(19) United States
(12) Patent Application Publication
(10) Pub. No.: US 2007/0177923 A1
(43) Pub. Date: Aug. 2, 2007

(54) Platen and printer

(75) Inventor: Kenji Eoka, Shizuoka-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/343,703

(22) Filed: Jan. 31, 2006

(51) Int. Cl. B41J 11/00

(52) U.S. Cl. 400/656

(57) ABSTRACT

A platen according to the invention has a metallic plate integrated thereto in such a manner that the plate surface is parallel to the direction of impact pressure applied from a printing section. Accordingly the platen has sufficient strength and rigidity even though being made of plastic, so that the platen is not deflected by impact pressure. A printer having the platen can maintain high print quality by preventing a decrease in print quality due to the deflection of the platen, thus reducing the cost of materials and achieving light weight.

### BACKGROUND OF THE INVENTION

1. Field of the Invention

The present invention relates to a platen opposed to the printing surface of a print head and a printer using the platen.

2. Description of the Related Art

Wire dot printers capable of overprinting on slips etc. are adopted for business use. The print head of the wire dot printers prints in a dot pattern by reciprocating a wire called a needle to bring the end of the wire into collision with a print medium, which is disclosed in, for example, Japanese Unexamined Patent Application Publication No. 6-255185.

In such wire dot printers, print media such as paper are disposed between the printing surface of the print head and a platen opposed thereto. The print media come into contact with the end of a needle let out from the printing surface of the print head via an ink ribbon, for printing in a dot pattern. The platen therefore comes under impact pressure by the needle via the print medium, so that it is required to have strong mechanical strength.

The platen has an elongated shape sufficient to cover the scanning direction of the print head (normally, in the direction of the width of print media). The impact pressure by the needle is applied from the longitudinal side of the platen. Accordingly, when the platen is made of a material with low mechanical strength and low rigidity, such as plastic, the platen will be deflected by the impact pressure of the needle. The interval between the platen and the printing surface of the print head is set precisely. Accordingly, if the platen is deflected, the interval between the platen and the printing surface changes, thus decreasing the print quality such as faint and patchy characters.

As noted above, platens are required to have high strength and rigidity. Accordingly, as shown in FIG. 1, a conventional platen has a structure in which an elongated iron squared pillar of a rectangular cross section is used as a core 11, around which an outer shell plate 12 of a U-shaped cross section is fixed. The outer shell plate 12 is made of a rustproof material such as stainless steel. The surface (on the left in the figure) of the outer shell plate 12 opposed to the printing surface of a print head (not shown) has a groove 12a along the length thereof (in the direction perpendicular to a paper surface). In the groove 12a, a platen rubber 13 made of hard rubber is integrally fixed. The platen rubber 13 is fitted in the groove 12a, with the back surface (on the right in the figure) bonded to the core 11.

The surface of the platen opposed to the printing surface is made flat by grinding the surface of the outer shell plate 12 including the platen rubber 13, with the platen rubber 13 being fixed thereto. As described above, since the surface of the platen opposed to the printing surface is ground to be flat, the outer shell plate 12 must be made of a rustproof material such as stainless steel. Using no rustproof material will form rust by grinding.

However, the use of a rustproof material for the outer shell plate 12 increases the cost of the material. Since the core 11 is made of a high-strength iron material, the weight of the entire platen will be increased and the cost of materials will increase.

### SUMMARY OF THE INVENTION

An object of the invention is to provide a platen that can be made lightweight with low material cost by using plastic in a wire area, in which a decrease in print quality due to deflection is prevented, and a printer including the platen.

According to an embodiment of the invention, there is provided a platen including: a plastic platen cover having a platen surface in which a platen rubber is integrally embedded, the surface facing the printing surface of a print head, and a support portion integrally extending from the back of the platen surface backwardly; and a metallic platen plate integrally mounted to the support portion, with the plate surface being perpendicular to the platen surface of the platen cover.

According to an embodiment of the invention, there is provided a printer comprising: a print head; a plastic platen cover having a platen surface in which a platen rubber is integrally embedded, the surface facing the printing surface of a print head, and a support portion integrally extending from the back of the platen surface backwardly; a metallic platen plate integrally mounted to the support portion, with the plate surface being perpendicular to the platen surface of the platen cover; and a medium feeding unit feeding a print medium between the printing surface of the print head and the platen surface of the platen cover.

### BRIEF DESCRIPTION OF THE DRAWINGS

FIG. 1 is a sectional view of a platen of a related art;

FIG. 2 is a schematic diagram of the internal constitution of a printer according to a first embodiment of the invention;

FIG. 3 is a perspective view of a platen according to the first embodiment of the invention; and

FIG. 4 is a sectional view of the platen according to the first embodiment of the invention.

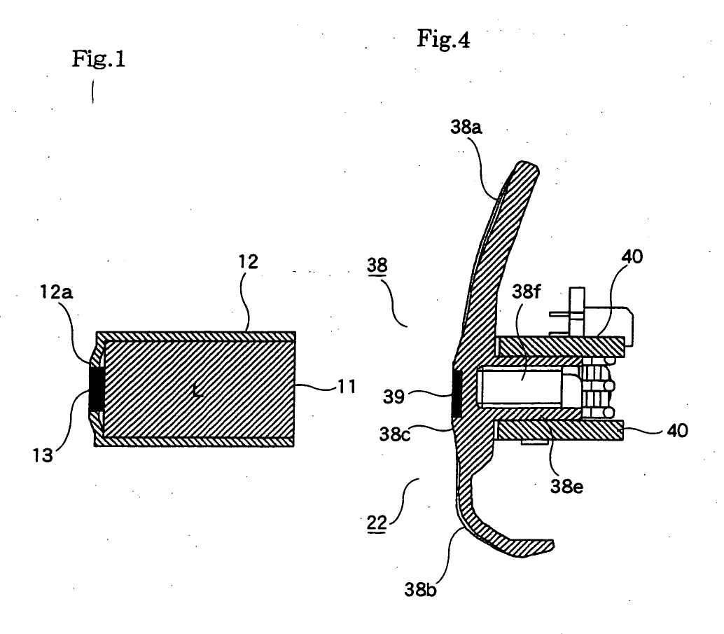

### DETAILED DESCRIPTION OF THE INVENTION

An embodiment of the invention will be described hereinbelow with reference to the accompanying drawings.

FIG. 2 is a schematic diagram of the internal constitution of a printer according to a first embodiment of the invention. In FIG. 2, reference numeral 21 denotes a printer body. The printer body 21 has a printing section 24 including a platen 22 and a print head 23, to be described later in detail, in the lateral center thereof. The printer body 21 also has a deflector roller 25 below the platen 22, and an exit pinch roller 26 above the platen 22.

A tractor 27 for feeding continuous-form paper or a print medium is disposed in the lower left of the printer body 21 in the figure. The tractor 27 feeds continuous-form paper from its outlet 27a to a first feed path 28. The first feed path 28 extends from the outlet 27a of the tractor 27 to a position under the deflector roller 25. Reference numeral 30 denotes a feed roller, and numeral 31 indicates a pinch roller, which are disposed on the back (on the left in the figure) of the printing section 24 in the printer body 21 for manual feeding of single-cut sheets. The feed roller 30 and the pinch roller 31 rotate with the outer peripheries thereof being in contact with each other. Inserting single-cut sheets between the rollers causes the single-cut sheets to be fed into a second feed path 32. The second feed path 32 is routed from the outlet of the feed roller 30 and the pinch roller 31 to the vicinity of the deflector roller 25 in the printer body 21, for conveying the single-cut sheets inserted between the feed roller 30 and the pinch roller 31 to the deflector roller 25.

The deflector roller 25 feeds the print paper conveyed through the first feed path 28 or the second feed path 32 toward the printing section 24 in the figure while warping it. Accordingly, the combination of the tractor 27 and the first feed path 28 and the combination of the feed roller 30, the pinch roller 31, and the second feed path 32 function as a feeder of print media (paper). The paper fed to the printing section 24 is printed between the platen 22 and the print head 23, and in turn sent upward in the figure by the exit pinch roller 26.

The print head 23 is of a wire dot type, which is disposed sideways in the figure on a carrier 35 together with a ribbon cassette 34 disposed behind it (on the right in the figure). The print head 23 is driven by the carrier 35 to reciprocate in the direction of the width of print paper (in the direction perpendicular to the paper surface). The wire-dot-type print head 23 prints on print paper via an ink ribbon by the reciprocating motion of a plurality of needles (not shown) toward the platen 22, the print paper being fed during the reciprocating motion. Specifically speaking, the ink ribbon is fed from the ribbon cassette 34, between the print paper and the platen 22 via a ribbon guide 36. Dot-pattern printing is thus performed on the print paper with the needles projecting from the printing surface (hidden behind the ribbon guide 36) of the distal end of the print head 23 (on the left in the figure) via the ink ribbon.

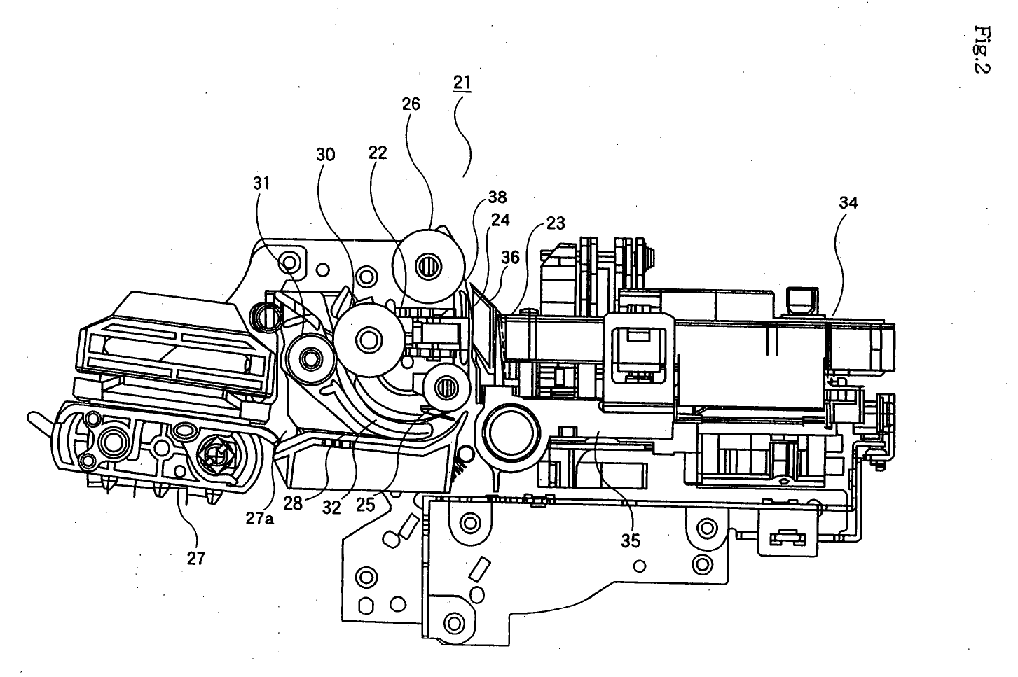

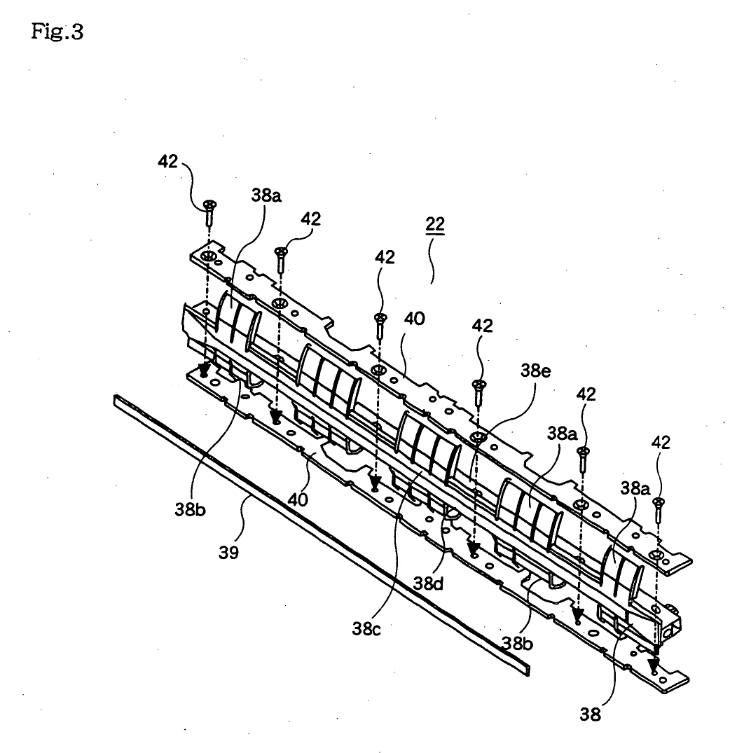

The platen 22 is long in the direction perpendicular to the paper surface so as to cover the reciprocating range of the print head 23. The general view of the platen 22 is shown in FIG. 3. In FIG. 3, the platen 22 is substantially constituted of a plastic platen cover 38, a platen rubber 39 made of hard rubber attached to the surface of the platen cover 38, and a metallic platen plate 40 for providing strength.

As shown in FIGS. 3 and 4, the platen cover 38 is made of a plastic elongated cover of a substantially T-shaped cross section. Partly integrated arc-shaped guides 38a and 38b are provided from the both sides of the upper bottom of the T-shape at regular intervals across the length. The surface of the upper bottom (on the left in FIG. 4) of the T-shape of the platen cover 38 forms a platen surface 38c opposed to the printing surface at the end of the print head 23 shown in FIG. 2. The platen surface 38c has a groove 38d across the length, in which the elongated platen rubber 39 made of hard rubber is integrally embedded. The platen surface 38c is ground with the platen rubber 39 being embedded, for providing accurate flatness.

The platen cover 38 also has a portion (hereinafter, referred to as a supporting portion) 38e corresponding to the leg of the T-shape and integrally extending from the back of the platen surface 38c backward, across the entire length of the platen cover 38. The platen plate 40 made of metal such as iron is joined to each of opposite two outer surfaces of the supporting portion 38e (the upper and lower surfaces in FIG. 4) for providing strength. As shown in FIG. 3, the platen plates 40 are integrally tightened with screws 42 that vertically pass through the supporting portion 38e. The platen plates 40 are integrated with the supporting portion 38e in the direction perpendicular to the platen surface 38c. This structure can therefore provide high strength against the impact pressure from the needles which is applied from the print head 23, thereby reliably preventing the deflection of the platen cover 38 due to the impact pressure.

The supporting portion 38e of the platen cover 38 has a hollow 38f in the portion through which the screws 42 shown in FIG. 3 do not pass, for reducing the weight, as shown in FIG. 4, thereby achieving light weight.

As described above, the platen surface 38c of the platen cover 38 faces the printing surface at the end of the print head 23 when mounted to the printer body 21, shown in FIG. 2. The exit pinch roller 26 or the deflector roller 25 is disposed within the length of the upper and lower arc-shaped guides 39a and 39b shown in FIG. 3.

In the printer with the above structure, shown in FIG. 2, continuous-form paper or print medium is fed by the tractor 27, and is sent from the outlet 27a through the first feed path 28 to a portion under the deflector roller 25. Manual feed single-cut sheets are fed from the feed roller 30 and the pinch roller 31, and are conveyed through the second feed path 32 to the vicinity of the deflector roller 25. Those print sheets are fed toward the printing section 24 at the upper part in the figure by the deflector roller 25. The printing section 24 prints in a dot pattern in such a manner that the needle projecting from the printing surface of the print head 23 is brought into collision with the print paper fed between the platen 22 and the print head 23 via the ink ribbon. The printed paper is sent out to the upper part in the figure by the exit pinch roller 26.

During the printing operation, the needle projecting from the print head 23 collides with the platen surface 38c of the platen cover 38, so that impact pressure is applied to the right in FIG. 4. The platen cover 38 itself has not high rigidity because it is made of plastic, but is provided with high rigidity against the impact pressure because the platen plates 40 made of iron or the like are integrally mounted to the supporting portion 38e. In other words, the impact pressure is applied to the platen cover 38 in the direction perpendicular to the platen surface 38c. However, since the platen plates 40 are disposed in parallel with the direction of the impact pressure, the platen cover 38 is given high strength and rigidity against the impact pressure, thus reliably preventing the deflection of the platen 22 due to the impact pressure. Thus a decrease in print quality due to the deflection of the platen 22 can be prevented.

In the foregoing embodiment, the two platen plates 40 made of iron or the like are integrally mounted to the plastic platen cover 38 in such a manner that they clamp the supporting portion 38e to obtain strength and rigidity. However, the number of the platen plates 40 is not limited to two. For example, one platen plate 40 may be integrated with the center of the thickness of the supporting portion 38e, or alternatively, total three platen plates 40, the platen plate 40 at the center of the thickness and the two platen plates 40 that clamp the supporting portion 38e from above and below may be used to reinforce the platen cover 38.

What is claimed is:

1. A platen comprising:
a plastic platen cover having a platen surface in which a platen rubber is integrally embedded, the surface facing the printing surface of a print head, and a support portion integrally extending from the back of the platen surface backwardly; and
a metallic platen plate integrally mounted to the support portion, with the plate surface being perpendicular to the platen surface of the platen cover.

2. The platen according to claim 1, wherein
a plurality of the metallic platen plates is mounted to the support portion of the platen cover.

3. The platen according to claim 1, wherein
the metallic platen plate is joined to each of the opposite two outer surfaces of the support portion of the platen cover, for integrally clamping the support portion.

4. A printer comprising:
a print head;
a plastic platen cover having a platen surface in which a platen rubber is integrally embedded, the surface facing the printing surface of a print head, and a support portion integrally extending from the back of the platen surface backwardly;
a metallic platen plate integrally mounted to the support portion, with the plate surface being perpendicular to the platen surface of the platen cover; and
a medium feeding unit feeding a print medium between the printing surface of the print head and the platen surface of the platen cover.
